(19) United States
(12) Patent Application Publication
(10) Pub. No.: US 2015/0312633 A1
(43) Pub. Date: Oct. 29, 2015

(54) ELECTRONIC SYSTEM AND METHOD TO RENDER ADDITIONAL INFORMATION WITH DISPLAYED MEDIA

(71) Applicant: BLOCKSENSE LLC, Canaan, NY (US)

(72) Inventor: Anthony MASCIAROTTE, Burbank, CA (US)

(21) Appl. No.: 14/642,737

(22) Filed: Mar. 9, 2015

Related U.S. Application Data
(60) Provisional application No. 61/949,586, filed on Mar. 7, 2014.

(51) Int. Cl. H04N 21/4725; H04N 21/8545; H04N 21/858; H04N 21/235; H04N 21/8547; H04N 21/431; H04N 21/218; H04N 21/231; H04N 21/81; H04N 21/472

(52) U.S. Cl. CPC H04N 21/4725; H04N 21/812; H04N 21/8133; H04N 21/8545; H04N 21/8583; H04N 21/47202; H04N 21/8547; H04N 21/8173; H04N 21/431; H04N 21/2181; H04N 21/231; H04N 21/2353

(57) ABSTRACT

An electronic device enabling and a method of displaying media with additional information using an electronic device having a display screen and a processing unit, the method comprising: defining encoded regions in a display area of the display screen, wherein the encoded regions are associated with the additional information that will be displayed when selected by a viewer; providing a utility that facilitate encoding the additional information in synchronization with the media and in association with the encoded regions; providing a player application which displays an image of the media in a designated display area of the display screen, and renders the additional information associated with a selected encoded region when a viewer places a pointer selectively over the selected encoded region of the display area, wherein the processing unit is configured to run the player application and render images on the display screen in accordance with requirements of the player application.

### CROSS REFERENCE TO RELATED APPLICATIONS

This application claims the priority of Provisional Patent Application No. 61/949,586, which was filed Mar. 7, 2014. This earlier application and all patent documents and other publications disclosed herein below are fully incorporated by reference, as if fully set forth herein.

### BACKGROUND OF THE INVENTION

1. Field of the Invention

The present invention generally relates to displaying media with additional information, and more particularly to associating and rendering contextual information with displayed media.

2. Description of Related Art

The current business model of content-creation is dependent on advertising revenue, but traditional in-stream advertising has become outmoded and ineffective. In-stream advertising is not meeting the demand by audiences for information, connectivity, access and interactivity. With the advent of VCRs, audiences were empowered to bypass in-stream advertising and it has become ever more commonplace with the popularization of DVR systems. Many viewers are opting not for broadcast television, but on-demand streaming programs on their personal computers, mobile devices and straight to their television sets.

In response to a media- and technology-rich culture, audiences' brains have been digitally rewired. Audiences are now demanding a new viewing experience, one that advertises to more specific audiences and time-points: audiences are asking for advertisements to be relevant to each and every viewer at each and every minute. They want to be advertised to effectively, and also efficiently. They are asking to be engaged on a high-level. Viewers are hungry for a more sophisticated viewing experience and in-stream advertising must be replaced to maximize its effect.

Content providers (any entity that has control over a piece of visual media, but traditionally understood to mean broadcast television networks) and advertisers are also becoming dissatisfied with available advertising paths. Advertisers commonly feel their message is lost, as commercials costly to make and air are “fast-forwarded” through. As a solution, some viewers have opted to purchase programming (whether on DVD or immediately through an internet purchasing system on a per-episode basis) or stream programming via the internet, bypassing instream advertisements altogether. Even worse, a subset of viewers obtains programming illegally through back channel downloads—advertisement-free. The advertising industry, based on the patronage of brands, is at a turning point. While some new media outreach has recently been incorporated into the viewing model, broadcasters and content providers are still not sure how to re-frame their role within the digital culture.

At the same time, advertisers and content providers wish to use new media to its fullest ability. Never before have they been able to have access to the amazing wealth of viewer data that is available to them with online, interactive advertising. The level of detail that can be tracked with online advertising is vast, and advertisers are anxious to receive that in a digestible form.

One thing is clear, any viable solution that integrates embedded advertisements must not detract from the viewing experience and instead enhance the viewing experience. Branded content and product placement, while useful, are easily recognized as inauthentic by audiences and content-creators alike. Audiences are more literary than ever, demanding high-quality entertainment delivered to their homes. The perfect solution will non-intrusively integrate information and advertising in a way that is engaging to the viewer.

Some work in this area has begun. Several existing systems seek to identify specific pixels of objects within video that contain links to external information, or super-impose labels onto specific areas of video. Such systems are either difficult to execute and therefore have not been embraced by content providers or do not sufficiently increase the quality of the advertising experience for advertisers and audiences alike.

There remains a need to provide an electronic system including applications to facilitate displaying media with additional information, and associating and rendering contextual information with displayed media.

### SUMMARY OF THE INVENTION

The present invention is directed to an electronic system and method for associating and rendering additional information or data with displayed media, and to deliver and display media with such contextual information.

In one aspect of the present invention, it comprises a method of displaying media with additional information using an electronic device having a display screen and a processing unit, the method comprising: defining encoded regions in a display area of the display screen, wherein the encoded regions are associated with the additional information that will be displayed when selected by a viewer; providing a utility that facilitate encoding the additional information in synchronization with the media and in association with the encoded regions; providing a player application which displays an image of the media in a designated display area of the display screen, and renders the additional information associated with a selected encoded region when a viewer places a pointer selectively over the selected encoded region of the display area, wherein the processing unit is configured to run the player application and render images on the display screen in accordance with requirements of the player application.

Other embodiments may include:
wherein the pointer is a cursor associated with a pointing device.
wherein the additional information is synchronized to the media based on timecode.
wherein the additional information is a link to content stored at a remote server.
wherein the encoded regions are arranged in a grid.
wherein the grid comprises rectangular areas defining the encoded regions.
wherein the additional information is contextual to the content of the image of the media currently displayed when the viewer places the pointer over the selected encoded region.
wherein the player application is configured to display media that is streamed, with the additional information synchronized to the streamed media.

In another aspect of the present invention, it comprises an interactive electronic device for displaying media with additional information, comprising: a display screen; a processing unit running a player application to display an image of the media in a designated display area of the display screen, wherein display area defines encoded regions that are associated with the additional information that will be displayed when selected by a viewer; wherein the media includes additional information encoded in synchronization with the media and in association with the encoded regions wherein the processing unit is configured to run the player application and render images of the media in the display area in accordance with requirements of the player application, and wherein the player application renders the additional information associated with a selected encoded region when a viewer places a pointer selectively over the selected encoded region of the display area.

In another aspect of the present invention, it may include a system for displaying media with additional information, comprising: an interactive electronic device as above; a remote server storing the additional information for encoding the encoded regions; wherein the electronic device communicates with the remote server over a network. The system may be centralized, and may further be unified.

### BRIEF DESCRIPTION OF THE DRAWINGS

For a fuller understanding of the scope and nature of the invention, reference should be made to the following detailed description read in conjunction with the accompanying drawings that depict system modules, functionality and processes.

FIG. 1 is a schematic diagram illustrating the Internet as one embodiment of a network environment in which the inventive game may be deployed.

FIG. 2 is a schematic diagram of an exemplary computing environment in which aspects of the invention may be implemented, in accordance with one embodiment of the present invention.

FIG. 3 is a schematic diagram illustrating the parties involved for the Rollover Player System.

FIG. 4A is schematic diagram illustrating the relationship between components of the Rollover Player System; FIG. 4B is a schematic diagram illustrating an overlay in accordance with one embodiment of the present invention.

FIG. 5A illustrates hovering over an overlay region in the display area; FIG. 5B illustrates hovering over another overlay region in the display area.

FIG. 6A illustrates a link to additional information at an overlay region in the display; FIG. 6B illustrates additional links that user can interact at various overlay regions in the display area; FIG. 6C illustrates advertisements at various overlay regions in the display area.

FIG. 7A illustrates additional information displayed at an overlay region in the display area; FIG. 7B illustrates additional information displayed at another overlay region in the display area.

FIG. 8 illustrates option to view or save advertisement displayed at a region in the display area.

FIG. 9A illustrates a Favorite and Information Panel at the side of the display area, in accordance with one embodiment of the present invention; FIG. 9B illustrates Ad Queue in the Favorite and Information Panel at the side of the display area, in accordance with one embodiment of the present invention; FIG. 9C illustrates saved embedded information in the Favorite and Information Panel at the side of the display area, in accordance with one embodiment of the present invention; FIG. 9D illustrates information in the Favorite and Information Panel may be reviewed on other devices.

FIG. 10A is a diagram depicting the processes involved in a viewer session, in accordance with one embodiment of the present invention; FIG. 10B is a diagram depicting the process for Rollover Player in displaying media, in accordance with one embodiment of the present invention; FIG. 10C is a diagram depicting process involved in viewer login and tracking, in accordance with one embodiment of the present invention.

FIG. 11A is a schematic diagram illustrating the relationship among a viewer, content provider and an advertiser, in accordance with one embodiment of the present invention; FIG. 11B is a diagram illustrating the process for the content provider to create HoverBoards, in accordance with one embodiment of the present invention; FIG. 11C is a diagram illustrating the process of content provider interacting with advertiser, in accordance with one embodiment of the present invention.

FIG. 12A is a schematic diagram illustrating the receiving/input mode of the Rollover Player Server; FIG. 12B is a schematic diagram illustrating the sending/output mode of the Rollover Player Server.

### DETAILED DESCRIPTION OF EMBODIMENTS OF THE INVENTION

The present description is of the best presently contemplated mode of carrying out the invention. This description is made for the purpose of illustrating the general principles of the invention and should not be taken in a limiting sense. The scope of the invention is best determined by reference to the appended claims.

The detailed descriptions of the system and process of the present invention are presented in terms of schematics, functional components, methods or processes, symbolic or schematic representations of operations, functionalities and features of the invention. These descriptions and representations are the means used by those skilled in the art to most effectively convey the substance of their work to others skilled in the art. A software implemented function, method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated by associated hardware, software and firmware.

Useful devices for performing the software implemented processes, operations and functions of the present invention include, but are not limited to, general or specific purpose digital processing and/or computing devices, which devices may be standalone devices or part of a larger system, portable, handheld or fixed in location. Different types of client and server devices can be configured to implement the electronic applications of the present invention further described below. For example, the various electronic applications of the present invention may be accessed using different types of client computing devices. The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like. For example, portable computing devices may include notebook computers, netbook computers, tablet devices, etc., and hand-held devices may include smart phones, PDAs (personal digital assistants), etc. Different types of media display systems can be configured to display the media and additional information in accordance with the disclosure below. Example of well-known display systems include, but are not limited to, smart televisions, computing devices having media players for displaying media.

These devices may be selectively activated or configured by a program, routine and/or a sequence of instructions and/or logic stored in the devices to execute the disclosed functions, processes and operations. In short, use of the processes, functions and operations described and suggested herein is not limited to a particular processing configuration. However, it is understood that the present invention is equally applicable to systems of other configurations embodying the invention, without departing from the scope and spirit of the present invention. That is, it is understood that the present invention could be applied to other types of dedicated or general application devices, currently known or future discovered, without departing from the scope and spirit of the present invention.

Overview and Background of the Rollover System

For purposes of illustrating the principles of the present invention and not by limitation, the electronic system of the present invention is described herein below by reference to an exemplary system, which will be hereinbelow referred to as the “Rollover Player System”. It is useful to set forth some of the terminology used throughout this disclosure:

Favorites and Information Panel: The Rollover Player Favorites and Information Panel is a browsing system for the information embedded in any encoded program, as well as a browsing system for the viewer's history within The Rollover Player.

API: Application Programming Interface, a protocol intended to be used as an interface by software components to communicate with each other.

Automated event creation: HoverEvent, HoverContent and Open HoverBoards are suggested through the use of graphic, text recognition software, and/or outside personnel.

Content Creator: Any entity that creates visual media. By way of example only, visual media may be a video, static image or slideshow. Also by way of example, a Content Creator may be a professional or amateur director, photographer, production company, television network.

Content Distributor: Any entity that controls and/or owns visual media. By way of example only, visual media may be a video, static image or slideshow. Also by way of example, a Content Distributor may be a broadcast television network, satellite or cable network, digital stream, internet channel or website.

Content Provider: Traditionally understood to mean broadcast television network, however in this context, Content Provider can be understood to mean any entity that shares visual media publicly or privately.

Direct Advertiser(s): An entity (such as individual, media buying company, advertising agency, brand) that seeks use of Open HoverBoards.

Engaged Region: A region of the Rollover Player that is engaged by a viewer, by one of manners disclosed herein.

High Exposure Region: A premium region that may be of a larger size relative to other regions, or may be more prominently featured on screen.

HoverBoards: (1) The matched pair of a HoverEvent containing HoverContent. (2) A software based (standalone or web-based) utility for advertisers to search and secure advertising opportunities, also allows content providers to sell unsold regions of a particular piece of media.

HoverContent: Information for display during a HoverEvent.

HoverEvent: Within the Rollover Player—a region, start-time and end-time.

ISAN/International Standard Audiovisual Numbers: A unique identifier for audiovisual works and related versions.

ISBN/International Standard Book Number: a unique numeric commercial book identifier based upon the 9-digit Standard Book Numbering code.

Low Exposure Region: A Low Exposure Region may be of a smaller size relative to other regions, or it may be somehow less visible than another region.

Manual event creation: The process of going through a piece of media (for example—a photograph, script, video) and inputting HoverEvents, HoverContent and/or creating Open HoverBoards.

Media Display Area: An area of a display screen of a display device, displaying the visual media. For example, a media display area may display a picture, slideshow, digital book or may be a video playback area.

Media or Visual Media or Visual Content: By way of example only, in this context “media” is taken to mean video, visual program, slideshow, image (static or dynamic), digital book, or other types of visual content.

Open HoverBoard: A HoverBoard that allows advertisers to input their own HoverContent, or a HoverBoard that's HoverEvent may be adjusted. A HoverBoard may be with or without restrictions.

Regions: Defined encoded regions or subdivisions of the Rollover Player. May be of any size and shape, may be of varying sizes and shapes, and/or may be combined to form any size and shape.

Rollover Encoder: A software based or web-based application that facilitates the process of encoding regions for display in The Rollover Player.

Rollover Player: a billboard-type overlay that divides a media playback or display area into regions that display advertisements and other information.

Rollover Player System: Comprising at least the Rollover Player, Rollover Encoder, HoverBoards as well as the logical flow of information between all parties involved.

Social Media Comment Follower: A ‘piano roll’ type system that tracks and displays all social media commentary and interaction within the Rollover Player display area.

stream_id: Within the context of the Rollover Player, a unique identification number assigned to a piece of media. It is used within the Rollover Player API.

Timecode: a sequence of numeric codes generate at regular intervals by a timing system. In this context, timecode refers to video and film timecode, or “SMPTE timecode,” which is used for synchronization and for logging and identifying material in recorded media.

User: User and/or users, in the context of individuals using the Rollover Player System to encode the Rollover Player, is understood to mean persons or entities who utilize Rollover Encoder, the encoding software application designed to encode and embed advertisements. These persons or entities may be but are not limited to content creators, providers, and/or advertisers and are considered the end-users of the software application “Rollover Encoder” developed as included in The Rollover Player System. User and/or users, in the context of individuals using theRollover Player to view media, are audiences.

Viewer: “Viewer” and/or “viewers” is understood to mean audiences of the visual media, and persons or entities that engage with the Rollover Player, also known as the end-users of the Rollover Player.

The Rollover Player System comprises a software implemented process that is designed to associate (e.g., link) and render additional information with displayed media (e.g., a movie, TV program, YouTube program, etc.), and to deliver and display media with such additional information. Such additional information may include contextual information related to the content of the media being display, and/or information relating to viewer's demographics or viewing history habits. In particular, at a high level, the Rollover Player System comprises the following primary components: (1) a billboard-type overlay that divides a media playback or display area into defined encoded regions that can display advertisements and other information during playback; (2) an encoding application (implemented in software) that creates files that pair with specific visual media in order to link (e.g., embed or encode) content, and more specifically contextual information (e.g., advertisements, or other information or data) that are related to the media content that is currently displayed within the encoded regions, and display the contextual information in those encoded regions when engaged, during media playback (as will be described below, the additional and/or contextual information is communicated through HoverBoards, embodying HoverEvent data); (3) a server where encoded libraries, information, data, content, and user (audience or viewer) data and interaction are stored; (4) Rollover Player, which facilitates viewing (e.g., including displaying, rendering, and/or visualization) of additional information (e.g., via a browser on an end user (viewer) device); (5) Rollover Player API Encoding Tool, which is a backend of the system that allows for encoding of files through parameters such as trigger times, HoverBoard actions and events; and (6) Rollover Player Server, which facilitates serving of additional information to the viewer in their native viewing device. Without limitations, the system may include additional components, or subcomponents that are included in these primary components described herein.

The Rollover Player allows content owners and or distributors to embed links, graphics, information and advertisements within multiple regions overlaid onto media playback or display areas in defined regions, such as an array of defined regions, or a grid-based defined regions. The Rollover Player surpasses the limitations of existing frameworks by utilizing a realistically implementable technology that produces a new method for interactivity with advertising, for content creators and distributors. The Rollover Player System is a solution for both audiences and advertisers. The Rollover Player API is a billboard-type overlay for any media playback or display area. As such, the Rollover Player may be used with existing media displayers as well as with custom displays, such as the Rollover Player of the present invention.

In the Rollover Player, in one embodiment, a media playback or display area is divided into billboard regions, either fixedly defined or user-defined. The playback area may be divided into small billboard regions and/or large billboard regions. The grid of defined regions can be dynamically arranged, allowing for a grid containing regions of varying sizes and shapes. The grid may take up the entire space of the media display area, or it may only take up a part of it. Additionally, the grid may be continuously active or it may require user activation to engage to render the additional data.

Defined encoded regions are activated when a viewer engages encoded regions by rolling over, hovering over or otherwise engaging regions with a cursor pointing device (e.g., as a mouse, trackball, etc.), a touch sensing device (e.g., a touch screen) or other type of physical or non-physical user interfacing device, triggering the rendition of items of additional data or information, which may include but not limited to: graphics, related product, brand, music, and links to other content and/or information contextually related to the media content currently being displayed at the engaged region on screen. The viewer may select within encoded regions to access information, play ads, save advertisements to a queue, and/or view further content within or outside of the Rollover Player. Ads and Info Links saved to a queue may be viewable within the Favorites and Information Panel of The Rollover Player.

The Rollover Player may include a Listing system, which includes Favorites and Information Panel, for the information embedded in any encoded program, as well as for the viewer's history within The Rollover Player. The Favorites and Information Panel can be navigated dynamically concurrent to media-viewing and may be displayed alongside the media playback or display area as well as on a separate device. The Favorites and Information Panel can also ‘float’ and be viewed regardless of whether or not the Rollover Player is being used to view any content at all. This enables the viewer to interact with their Favorites anytime and on any viewing device (e.g., phone, tablet, television set, etc.)

To access embedded/linked additional (e.g., contextual) information, a viewer selects and/or engages the encoded, defined regions to access real-time, media program-related information or links to such information, which may be graphics and information such as music and music purchase information, or content owner/creator information as well as program availability. Viewers may also engage defined regions that are reserved for advertisements. By “hovering” over these defined regions, the viewer may access advertisements that are generally tailored to the media program, and more specifically to the media content currently displayed at the defined regions, which may be further tailored to the media programming's actual demographic, and/or tailored to the viewer and/or the viewer's specific history. The viewer may choose to access the advertisements concurrent to viewing the program and navigate information dynamically within the Favorites and Information Panel and/or the viewer may choose to save the information for later access.

The Rollover Player is a targeted solution for advertisers, content creators (those who own and or control visual media such as video, slideshow, digital book or static visual content) and content distributors (such as standard broadcast networks as well as emerging media types), as it displays advertisements and information that are uniquely relevant to program content and viewer demographic. In the Rollover Player System, advertisements can more specifically correspond to program content than with traditional in-stream advertising because of ability to flexibly match advertisements with script events. For example, an advertisement placement can correspond to on-screen products—a car, pizza or clothing can be linked to encoded regions that correspond to both timecode and position in the viewing area.

Because of the many regions available for encoding, as well as the ability to specify durations for the embedded advertisements and information, The Rollover Player System creates multiple points of access to the viewer, which facilitates advertising opportunities that are on-target and time-sensitive.

The Rollover Player System also creates advertisement placements that are uniquely relevant to program viewership. Content providers may have access to viewers' actual locations and other demographic information that may provide a huge advantage over traditional revenue streams. Viewers' browsing information may be consensually supplied to content creators and distributors to provide insight into the efficacy of the advertisements, creating a feedback loop in which advertisers create advertising content, viewers engage with the advertising content in a meaningful way, this engagement is reported on to advertisers and advertisers can restructure their advertising and techniques to more effectively engage audiences.

The technical process of encoding regions with additional content is done through the use of a separate encoding software based application called Rollover Encoder (Rollover Encoder API). Content owners and distributors utilize the encoding software to embed program information and advertisements within the regions of the media playback or display area. Regions may be banded together and merged to create custom shapes and sizes to correspond with specific on-screen events and items. Content distributors can manually tag scripts, books, photos and videos with key words, items, products, brands, events, themes and/or other possible moments or items of interest, and text recognition and visual recognition software may be used to analyze scripts, books, photos and videos to do the same. The Rollover Encoder API creates a file that pairs to a specific piece of visual media and ties all programmatic events to industry standard timecode and International Standard Audiovisual Numbers. Content owners and distributors may also use this software to track their reports from audience engagement, thus creating the feedback loop necessary for advertising to continually evolve and maximize the viewing experience for audiences.

The Rollover System uses HoverBoards, which enables direct market fulfillment of region advertising space. HoverBoards is a utility for advertisers to search and secure advertising opportunities via a simple software and/or web-based interface which also helps content providers to sell unsold regions of a particular piece of media, event or stream. The Rollover System includes these specific components as well as the logical flow of information between all parties involved.

In another aspect of the present invention, the system functions may be centralized, with the complementary user and/or viewer related functions in network communication with the electronic system (e.g., encoder and viewer).

In one embodiment shown, the Rollover System may comprise a centralized and unified electronic system residing in a remote server, which communicates over a network.

As used throughout herein, “unified” refers to user perspective of unification of functions (e.g., most of the back-end encoding and playback functions) in a system, which system provides functions such as facilitating user encoding of additional (e.g., contextual) information with media, delivering media and associated additional information to a viewer, etc.; and “centralized” refers to the management of more critical activities and/or components at a centrally managed device or a group of devices in a single location or a cluster of distributed locations that are logically linked (collectively, a “remote server”).

Computing Environment Including Information Exchange Network

The Rollover System in accordance with the present invention comprises software implemented processes, which may involve, without limitation, a distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

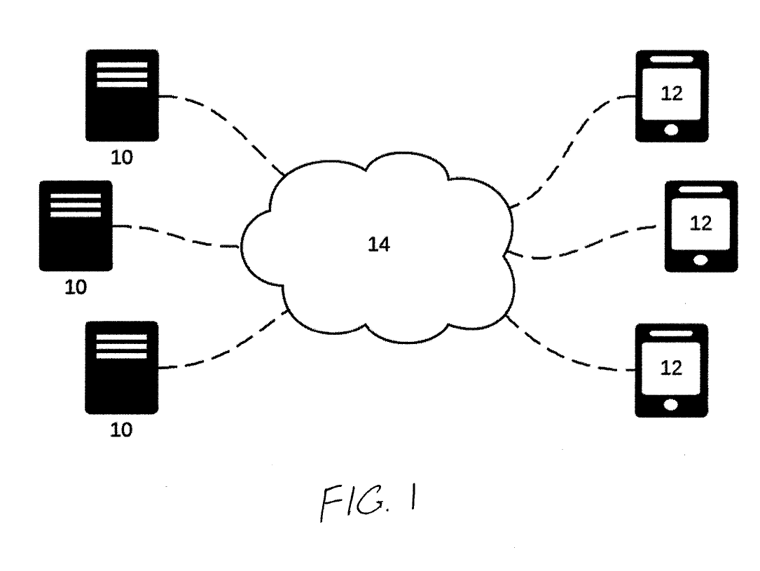

The Internet is an example of an information exchange network including a computer network in which the present invention may be implemented, as illustrated schematically in FIG. 1. Many servers 10 are connected to many clients 12 (which may be desktop, portable and/or handheld devices) via the Internet network 14, which comprises a large number of connected information networks that act as a coordinated whole. Details of various hardware and software components (such as servers, routers, gateways, etc.) comprising the Internet network 14 are not shown as they are well known in the art. Access to the Internet by the servers 10 and clients 12 may be via suitable transmission media, such as Ethernet, satellite, telephone wires, wireless RF links, Wifi, Bluetooth, or the like, and user interface tools, such as browsers, implemented therein. Communication between the servers and the clients takes place by means of an established protocol. Various applications of the present invention described below may be configured in or as one or more of the servers 10, which is accessible by a user (e.g., an encoder or a viewer) via one or more of the clients 12.

The “center” of the Rollover System may be implemented in one or more of the remote servers 10, which manages the entire centralized and/or unified system.

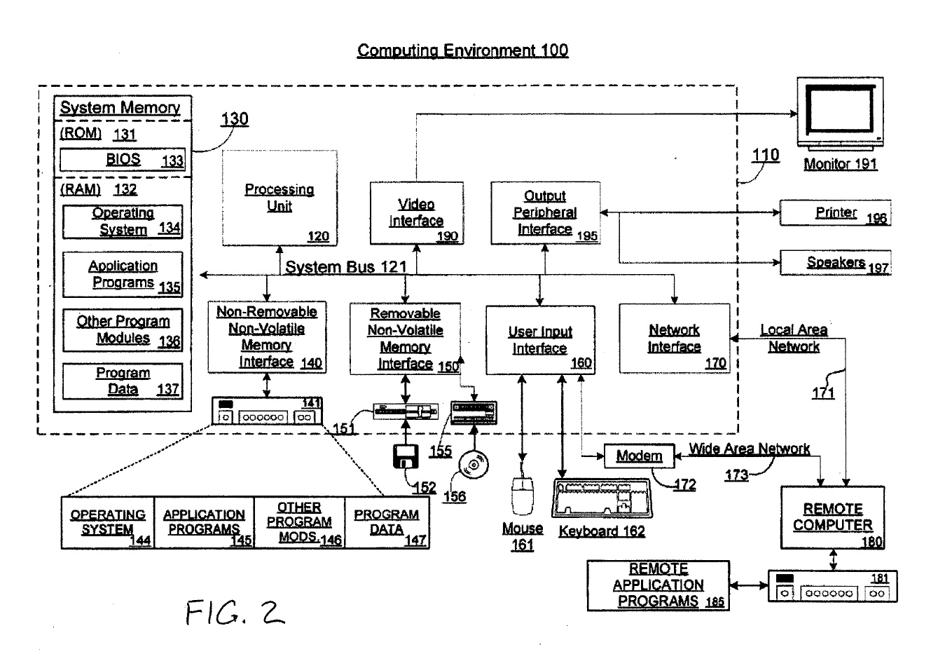

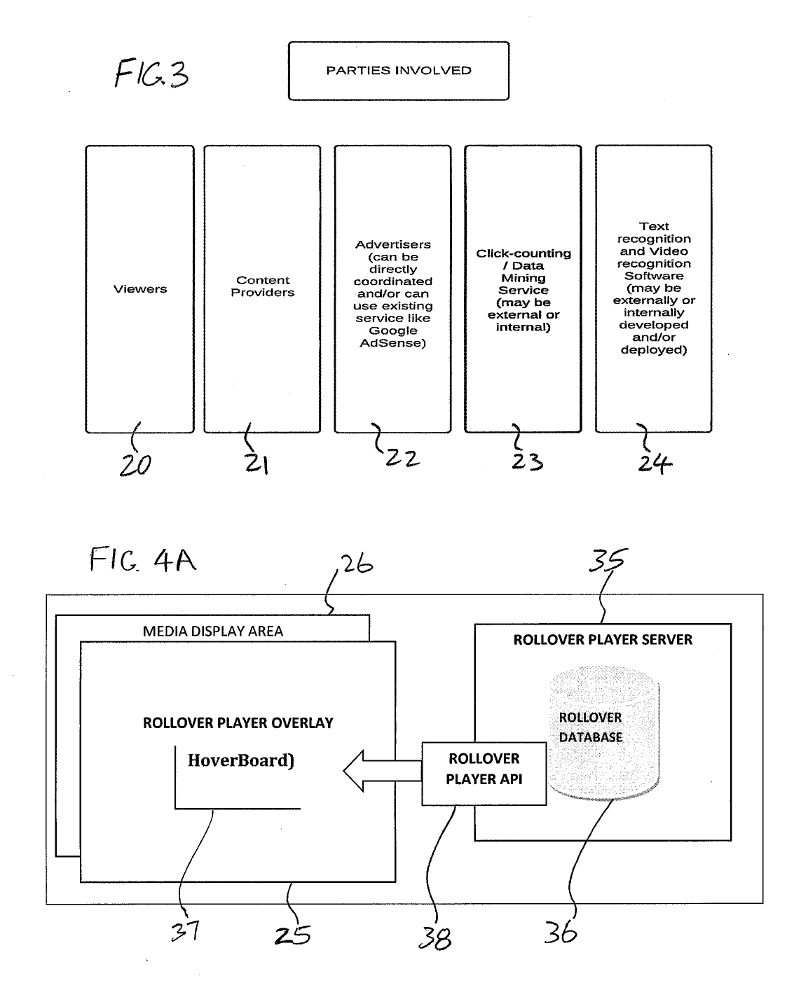

FIG. 2 shows an exemplary computing environment 100 in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types, including the networked based (e.g., web-based) application of the system and process described herein below. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 2, an exemplary system for implementing the invention includes a general purpose computing device in the form of a computer 110 (which is exemplary of the components adopted by servers and/or clients). Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. Communication media typically embodies computer readable instructions, data structures, program modules or other data in a modulated data signal (i.e., a signal that has one or more of its characteristics set or changed in such a manner as to encode information in the signal) such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137. The application programs 135 may include some of the program modules of the inventive Rollover Player System.

The computer 110 may also include other removable/non-removable, volatile/nonvolatile computer storage media. By way of example only, FIG. 2 illustrates a hard disk drive 141, a magnetic disk drive 151 that reads/writes a removable magnetic disk 152, and an optical disk drive 155 that reads/writes a removable optical disk 156, such as a CD ROM or other optical media. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. The pointing device may be used for “hovering” in the inventive Rollover Player System. Other input devices (not shown) may include a microphone, joystick, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 can be used to display media program and additional information encoded in HoverBoards in accordance with the present invention. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules accessible by the computer 110, or portions thereof, may be stored in the remote memory storage device 181. By way of example, and not limitation, FIG. 2 illustrates remote application programs 185 as residing on memory storage device 181 associated with the remote computer 180. It will be appreciated that the network connections shown are exemplary and other means of establishing a communications link between the computers may be used.

In the below disclosed embodiment of the present invention, the Rollover System of the present invention may be implemented in a the network-based application represented by the remote application programs 185 residing in the memory storage device 181, which is accessed by the computer 110 and executed via the remote computer 180, within the environment shown in FIG. 2. In other words, the remote computer 180 undertakes the functions of a server, and the computer 110 undertakes the role of a client, in reference to the network environment shown in FIG. 2.

This invention works in conjunction with existing technologies, which are not detailed here, as they are well known in the art and to avoid obscuring the present invention. Specifically, methods currently exist involving the Internet, web based tools and communication, and related methods and protocols.

### Components of the Rollover Player System

In addition to the Rollover Player and Rollover Encoder, the Rollover Player System uses and displays HoverBoards, in a grid based interface, which appear in proximity of the viewer's engagement. Each HoverBoard can be programmed to hold several varying HoverEvents and Content. Within the framework of The Rollover System, specific functionality and action of the grid, position of each HoverBoard and the HoverEvents included, are assigned using the Rollover Encoder API. The Rollover Player System includes these specific components as well as the logical flow of information between all parties involved. This includes the analytics embodying the experience and actions that occur with any interaction within the Rollover Player.

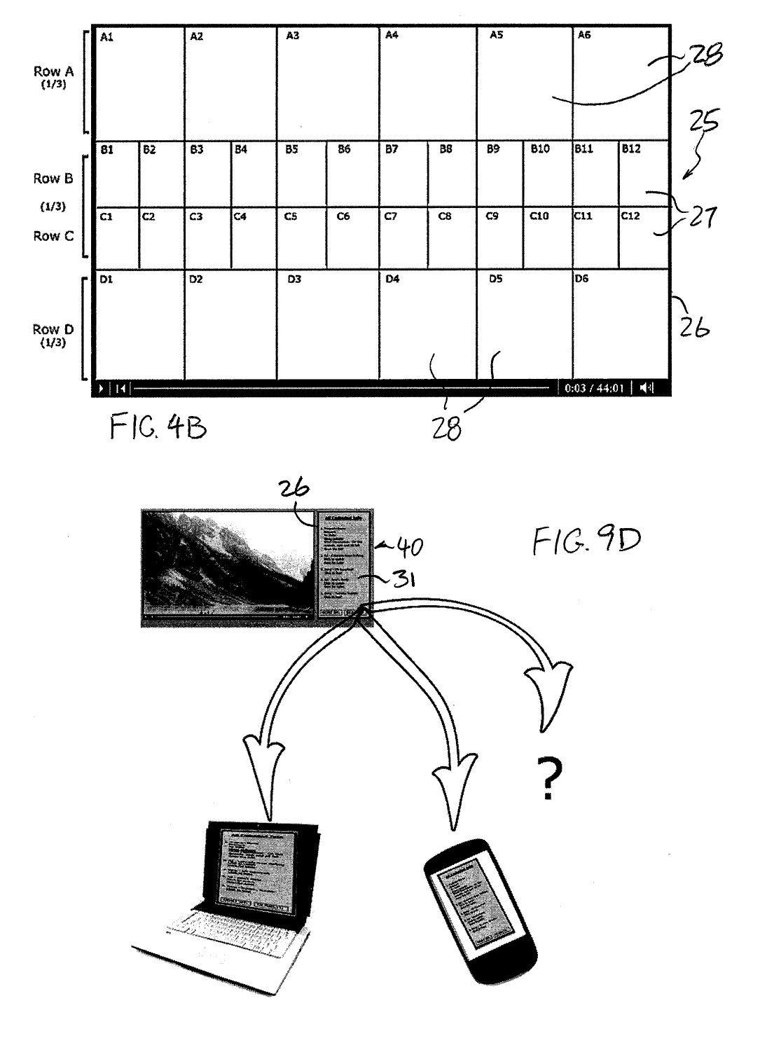

Each component of The Rollover Player System involves different participants. Referring to FIG. 3, The Rollover Player is used by viewers (20) of visual media on any device capable of media playback (e.g., a tablet, a computer monitor, a television set (e.g., a smartTV), etc.). The Rollover Encoder is used by content owners and content distributors (21) (of any visual media or content—for example: video, slideshow, digital book or static image) to encode regions for display via the Rollover Player (at block 21). There are advertisers (22) desired to place advertisements to be associated with the visual media, click-counting/data mining service providers (23) who tracks hits to advertisements, and text recognition and video recognition devices (24) (e.g., software based) that facilitates encoding of media content with additional information.

A. The Rollover Player

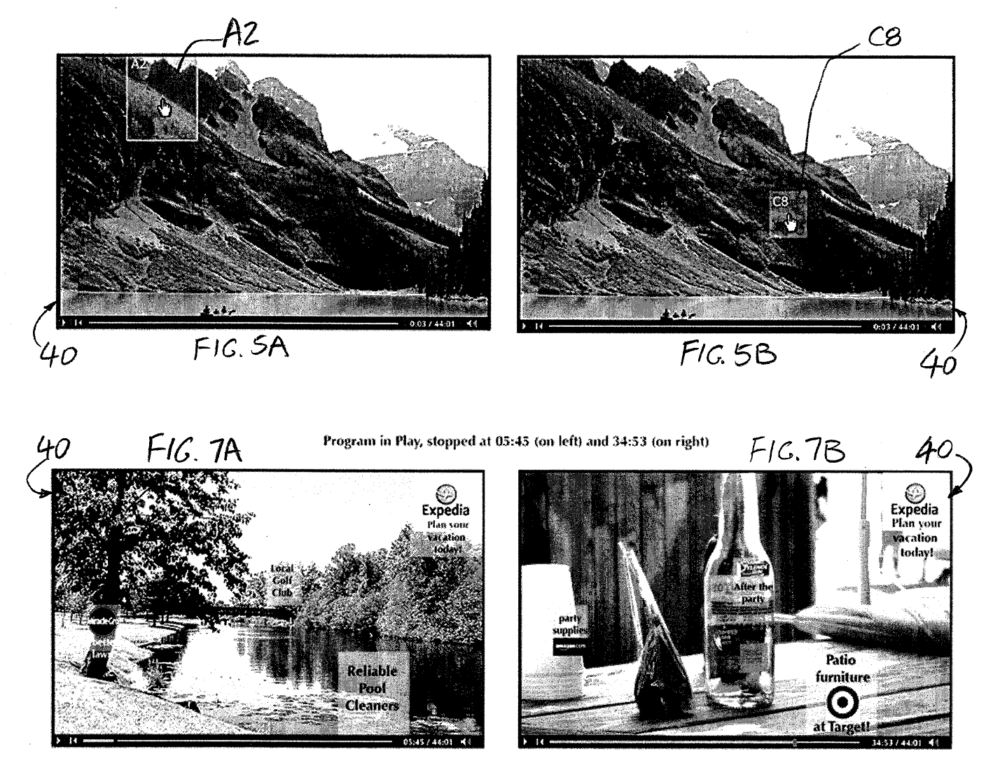

FIG. 4A schematic illustrates the relationship of the Rollover Player overlay 25 and associated HoverBoard 37, the media display area 26, the Rollover Player Server 35 having an associated database 36, and the Rollover Player API 38. These items are discussed more fully below.

FIG. 4B illustrates an embodiment of the Rollover Player's billboard-type overlay 25, which is for use with any visual media (for example: video, slideshow, digital book or static image) and any media playback or display system. As such it may be used with existing video players, slideshow, digital book players or image display techniques as well as with the inventive custom display system, the Rollover Player. The billboard-type overlay 25 divides a media playback or display area 26 (i.e., defined by the overall rectangular boundary shown in FIG. 4B) of a display screen of a display device into defined regions 30 of fixed or malleable size. The playback area 26 may be divided into smaller regions 27 (e.g., High Exposure Regions) at the center-focus of the playback area and large regions 28 (Low Exposure Regions) at the periphery of the playback area 26. In the illustrated embodiment, these regions 27 and 28 are laid out across the billboard-type overlay in a simple array of rectangular grid. Here is an example of how the regions may be divided: First, the media playback or display area 26 is divided vertically into thirds. In the first third, Row A may contain a row of six Low Exposure Regions 28 of equal size. In the second third, two rows of equal height (Rows B and C) may each contain twelve High Exposure Regions 27 of equal size. In the last third, Row D may contain a row of six Low Exposure Regions 28 of equal size.

Even though the overlay 25 is shown as a rectangular grid, it is understood that the overlay may be configured with defined regions of other geometries, shapes and/or sizes, arranged in an orderly, semi-orderly or random array or grid. The playback area 26 could be any geometric configuration (a circle, square or other).

The fixed grid illustrated in FIG. 4B is one embodiment of the configuration and arrangement of the regions. However the billboard-type overlay can be configured as a flexible system allowing for a dynamically adjustable grid containing regions of different sizes and shapes, and further a user-configurable grid that the user may manipulate to define the number, size and shape of defined regions.

The overlay of the Rollover Player does not have to occupy the entire media display area of the screen of the display device. It could be placed over only a portion of the screen. Additionally, The Rollover Player may be continuously active, or require activation by the viewer, or may be turned off by the viewer.

A region is activated when a viewer selects said region by rolling over, hovering over or otherwise engaging regions with a cursor pointing device (e.g., mouse, peripheral device, gestural method, touch screen or other any physical or non-physical interface). “Hovering”, “Roll over” or “rolling over” is understood to mean engage, engaging via programmatically engaging. This can be accomplished by rolling over, hovering over or otherwise engaging with the cursor associated with a cursor pointing device. FIGS. 5A and 5B illustrate two examples of a viewer selecting an encoded region in two separate instances, based on the configuration of overlay 25 in FIG. 4B. FIGS. 5A and 5B illustrates an image displayed by the Rollover Player 40. In FIG. 5A, the viewer hovers over Region A2, a Low Exposure Region. In FIG. 5B, the viewer hovers over region C8, a High Exposure Region. As illustrated, a pointer or cursor in the shape of a hand with an extended finger, is placed in the above noted regions in FIGS. 5A and 5B.

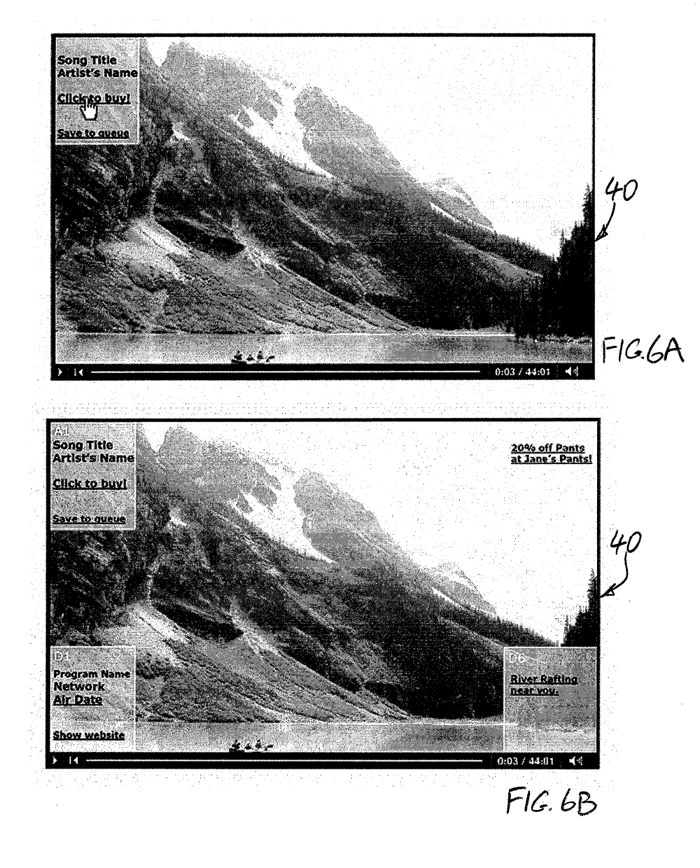

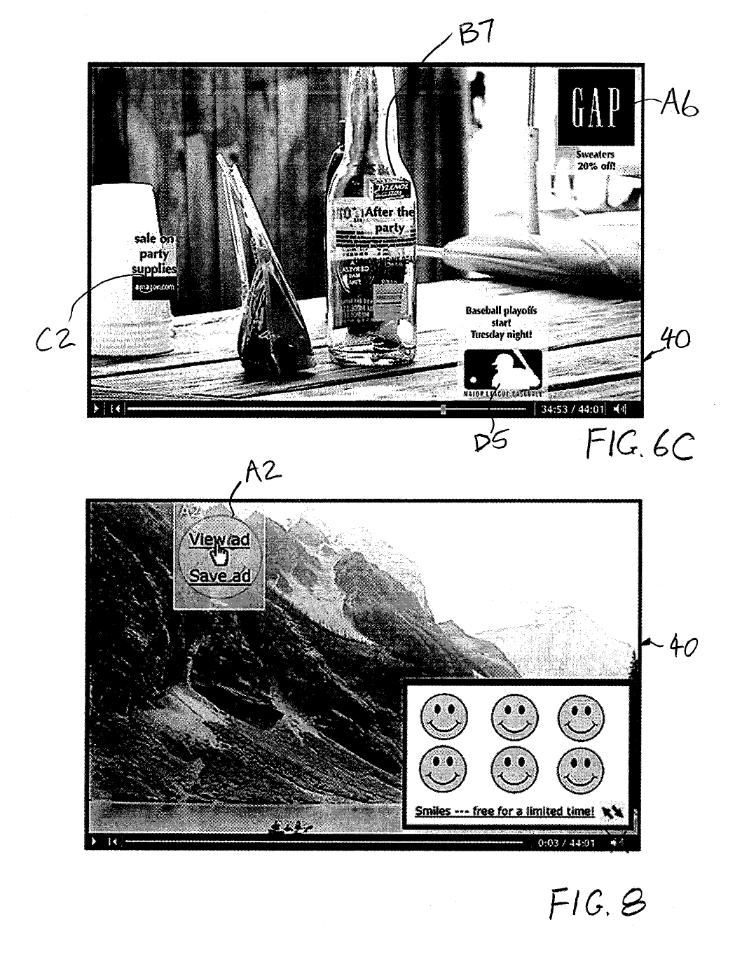

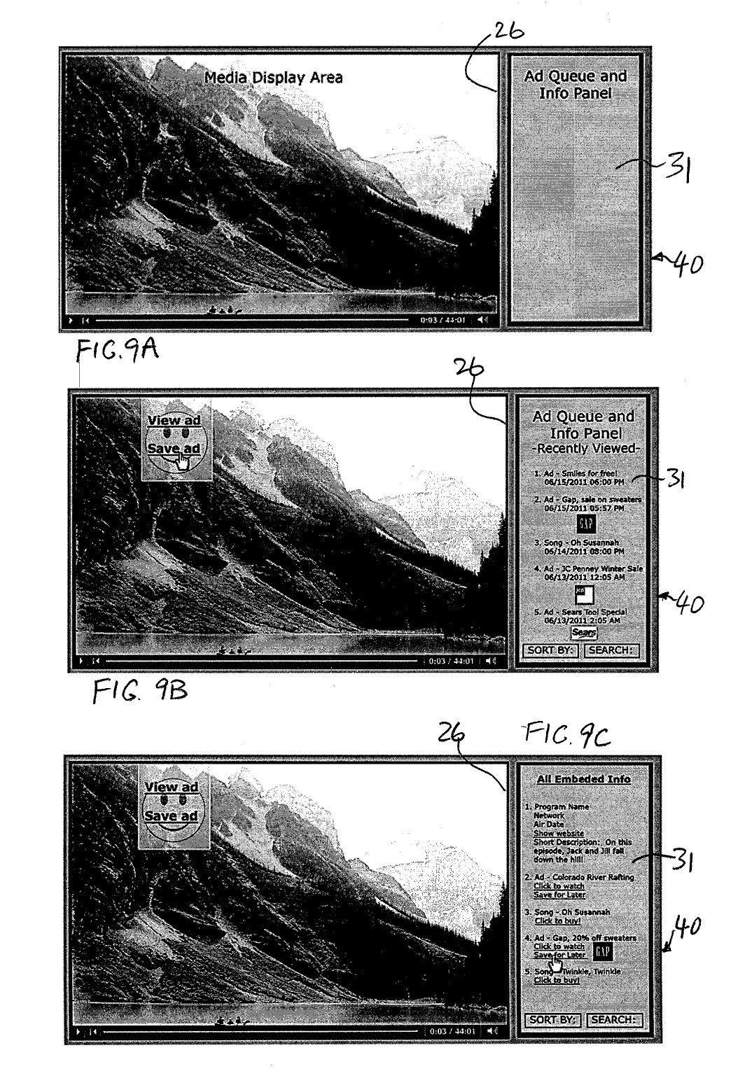

If the viewer selects and then chooses (by selecting, clicking on or otherwise engaging) areas within fixed or unfixed regions, links, graphics, text, video, other content and/or real-time program-related information may be displayed. “Click” or “clicking” may be implemented by an act can be performed in any way including but not limited to engaging with a cursor pointing device, such as a mouse, peripheral device, touch screen, gestural method, or any other physical or non-physical interface. Referring to FIG. 6A, for example, the utmost upper-left region (possibly in Region A1) may be reserved strictly for music information. By clicking this region at a specific time in the program, certain song information will be displayed. In addition, a link to purchase the music may also be displayed in the region, streamlining the sales process for music placed within a program and allowing the viewer instantaneous gratification. Referring to FIG. 6B, other fixed-region content may be program information (possibly in Region D1), available discounts (possibly in Region A6), and/or local options (possibly in Region D6).

When regions are activated, a graphic, link, text, sound, video and/or other content may be presented within the activated region, as show in the example in FIG. 6C. Some other items for display in activated regions may include but are not limited to a logo, other image, brand or product information, a link to externally or internally hosted video or video advertisement, and/or a link to save the content to a Favorites List for later viewing or social sharing. Some regions may contain information, while other regions may contain advertisements. These advertisements may be general, tailored to the program content, or tailored to the viewer's demographic, specific history and/or location. Clothing worn by a character in the program may be advertised in a corresponding or non-corresponding region, a national or local pizza company may choose to purchase ad-space when the program characters order a pizza, or a car-company may purchase ad-space simply because a program-reaches their target demographic. All available regions may contain embedded content or just a few may contain embedded content.

Specifically as shown in FIG. 6C, the displayed information in the regions C2, D5, B7 and A6 (based on overlay 25 in FIG. 4B) are contextually related to the content of the visual media currently displayed at the location covered by those regions. In particular, Region B7, which covers the displayed image of a beer bottle, displays information/advertisement concerning headache medication “Tylenol” for “After the party” use. Region C2, which covers the displayed image of disposable cups, displays an advertisement for “sale on party supplies” by the online retailer “Amazon”. Region A6 may display an advertisement of retailer “GAP” for “Sweaters 20% off!”, which is tailored to the viewer's demographic. Region D5 may display promotional information such as “Baseball playoffs start Tuesday night!”, which is tailored to the viewer's demographic or which associates beer drinking with advertisement for sports programs. The Regions A6 and D5, being Low Exposure Regions, are being used in this example to display more general additional information that may not be associated with the content of the media disclosed in such regions. It is believe that displaying such information at the Low Exposure Regions A6 and D5 would not be distracting to the viewers, given that these regions are closer to the boundary (e.g., corner) of the display area.

Regions may contain embedded content for the entire length of a program or only for a specified duration. FIGS. 7A and 7B illustrates regions of the Rollover Player 40 containing embedded content for a program over a period of time of about 30 minutes.

FIG. 8 shows an example of viewer use of the Rollover Player 40 in which the viewer has selected Region A2 and is presented with two options: the viewer may choose to “view ad” to watch an advertisement concurrent with the program or “save ad” to Favorites list for storage and future viewing.

Video content, such an advertisement, that plays concurrent to program playback may be played within the media playback or display area in a separate and defined area, in the Favorites and Information Panel, in other windows, on a completely separate device, and/or in the main media playback or display area while the program playback is paused or playing in a different space.

FIGS. 9A to 9C illustrate an embodiment in which content saved to a viewer's Favorites can be accessed in the Favorites and Information Panel 31 of The Rollover Player, or other access methods. The Favorites and Information Panel 31 is a browsing system for a viewer's browsing history and the information embedded in any encoded program. The Favorites and Information Panel 31 can be navigated dynamically, concurrent to program viewing. The Favorites and Information Panel 31 may be displayed alongside the media playback or display area 26, as in the Rollover Player, or even on a separate device (as shown in FIG. 9D).

Further information, advertisements, links, purchasing opportunities, video or other content may also be displayed in the Favorites and Information Panel 31.

The viewer will be able to tag, comment or link with the content displayed or the HoverEvents associated with that content, and send directly to their personal social media platform of choice (in that application's native format and protocol). Specific to the timecode and content of the particular HoverEvent. Social media commenting may be displayed at its point of tagging, as the program content plays in real time, as though all comments are a live comment feed.

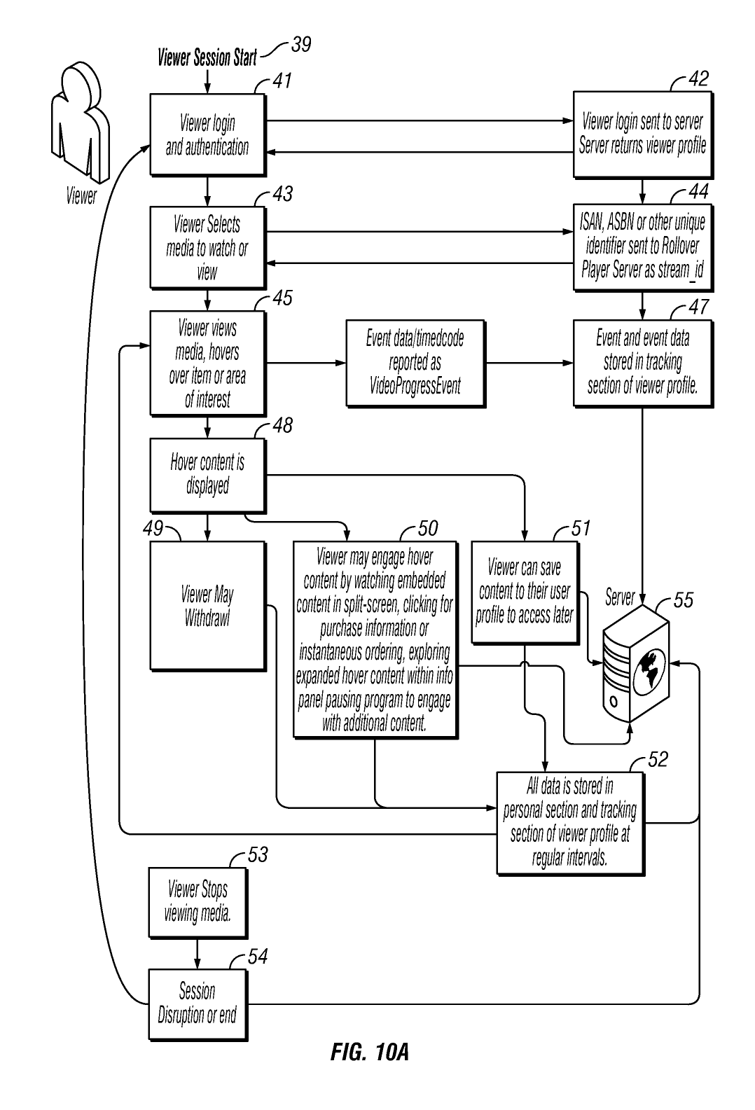

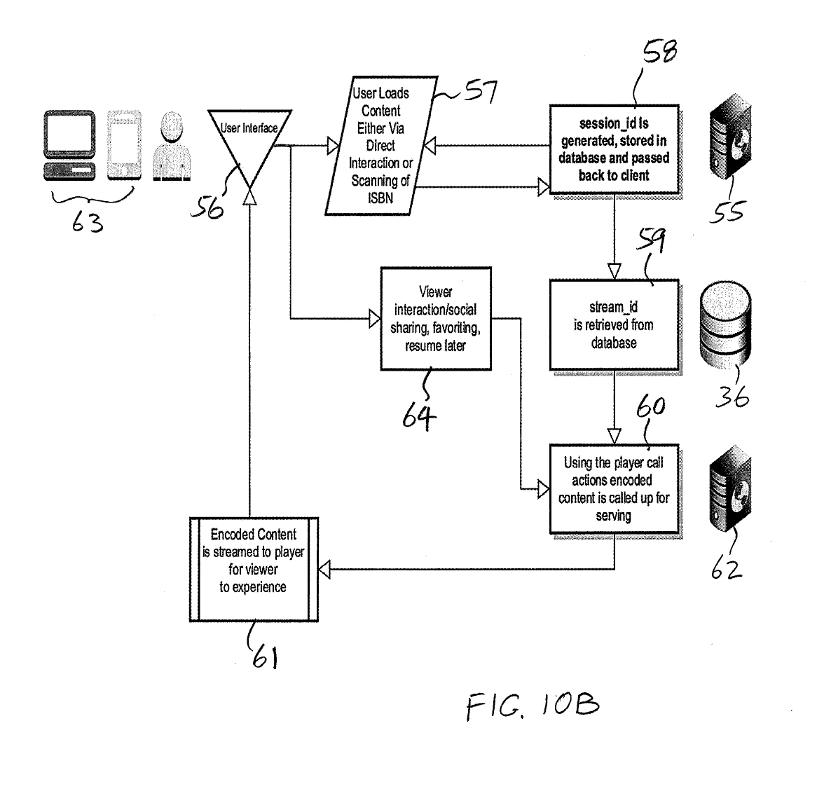

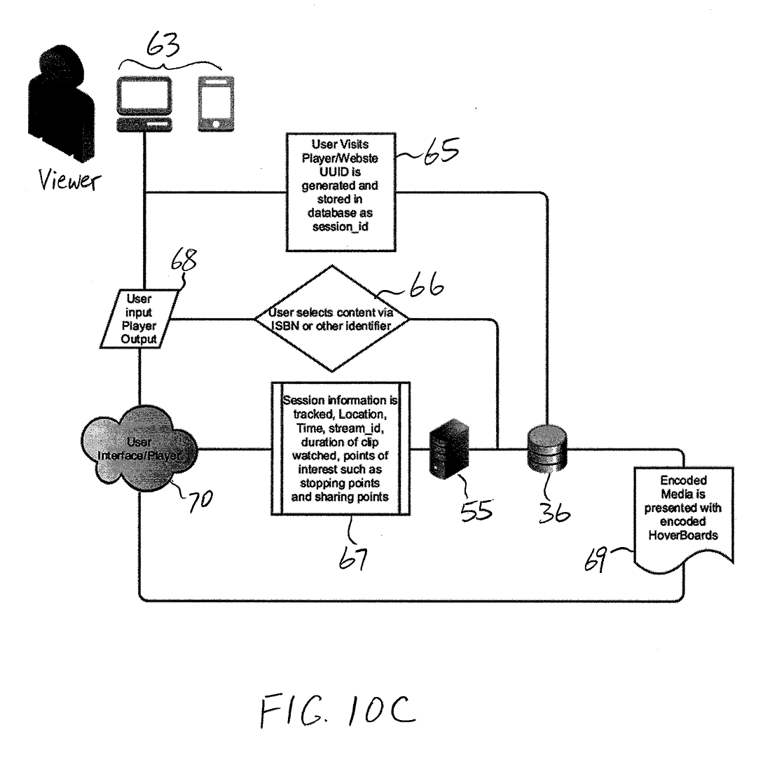

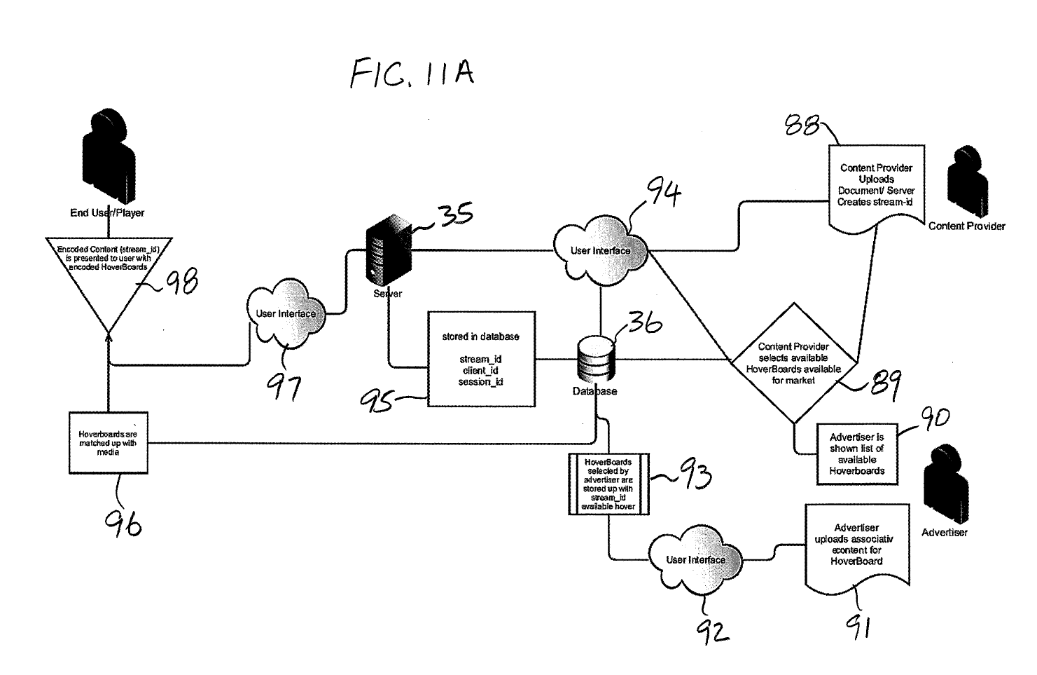

FIG. 10A illustrates the viewer experience in a viewer session with the Rollover Player 40. At start of viewer session (39) (e.g., by viewer launching a software based application for the Rollover Player), viewer login and authentication (41) (e.g., at a viewer client-device, such as a tablet, personal computer, etc.), viewer login information is sent to a server 55 (e.g., the Rollover Player Server 35 in FIG. 4A, which may be one or more of the servers 10 shown in FIG. 1), which returns the viewer profile (42). Viewer selects media to watch (43). ISAN, ISBN or other unique identifier sent to server as stream_id (44) (also from (42) as appropriate). Selected media is served to viewer. Viewer starts to view media, and may hover over item or area of interest (45). The even data/timecode is reported as VideoProgressEvent and the viewer hovered region (e.g., based on an overlay 25 shown in FIG. 4B) is also report to the server 55. (46). These two reported items may be attached to each other as EventX. Event and event data are stored (e.g., at a storage device in or associated with the server 55) in tracking section of viewer profile (47), from (44) and (46). The hover content is displayed at the viewer's display device (48). At this point, viewer may do at least one of the following: (a) withdraw (49); (b) engage hover content by watching embedded content in split-screen, clicking for purchase information or instantaneous ordering, exploring expanded hover content (e.g., within Favorites and Information Panel 31 shown in FIG. 9) (50); or (c) save content to their viewer user profile to access later (51). All data is stored in personal section and tracking section of viewer profile at regular intervals (52). Viewer may continue to view the media program, and go through further cycle(s) of hovering, clicking, and viewing the additional (e.g., contextual) information, storing Favorites, etc. Viewer may stop viewing media at any time (53) and exit viewer session (54).

FIG. 10B more specifically elaborates on the interaction of the Rollover Player 40 for displaying media content. Using viewer user interface 56 (which could be a display screen on a client device 63, such as a tablet, personal computer monitor, etc.), user loads content either vis direct interaction (e.g., clicking on an icon representing the particular media content to be selected), or scanning of ISBN (57), session_id is generated, stored in database at the server 55 and passed back to the client device 63 (58). Stream_id is retrieved from database 36 (59). Using the Rollover Player call actions, encoded content is called for serving to the viewer (60) (e.g., from a media server 62), and the encoded content is streamed to the display of the viewer client device 63 (e.g., loaded with Rollover Player 40 as in FIG. 7)) for viewer to experience (61) at the viewer user interface 56. Alternatively at (64), there may be viewer interaction/social sharing, favoriting, etc. and viewing can be resume later.

FIG. 10C more specifically elaborates on the viewer login and tracking aspect. Using a Rollover Player 40 on a client device 63, viewer user visits a media site, and player/website UUID is generated and stored in data base 55 as session_id (65). The user input/Player output (48) allows the user to select content via ISBN or other identifier (66). Via user interface/Player 70, session information is tracked, e.g., Location, Time stream_id, duration of clip watched, points of interest such as stopping points and sharing points (67) by the server 55. Encoded Media is presented (e.g., by media server 62 in FIG. 10B) with encoded HoverBoards 27 (69) (see FIG. 4A).

B. Rollover Encoder and API

The technical process of encoding regions according to an overlay 25 with additional content is done through the use of a software based application (which may be standalone and/or web-based) referred herein as the Rollover Encoder (including Rollover Encoder Application Programming Interface or Rollover Encoder API). Content providers (entities who control and/or own visual media, examples of which are video, slideshow, digital books and static images) are the primary users of this encoder application. They will utilize the encoding software based application to embed additional information, such as advertisements, and their associated ID and web locations, called HoverEvents within the gridded HoverBoard regions (in accordance with overlay 25) of the media playback or display area of the Rollover Player. The ease of use with The Rollover Encoder is high, as it is designed to make the process as simple as possible.

To encode a piece of visual media with additional information (e.g., contextual information), the content provider first enters the address and ID, or uploads the file to the host server, containing the visual media (such as video, slideshow, digital book or static image) into Rollover Encoder. Then adds any unique identifiers available (the video's International Standard Audiovisual Number (ISAN) or a book's ISBN), if applicable. If applicable, the content provider may also load the text of the script and accompanying timecode. Rollover Encoder assigns the media a unique identification number, known to the Rollover Player API as the stream_id. Through a manual and automated process, the content provider then defines HoverEvents, within the chosen HoverBoards available. A HoverEvent is a HoverBoard's start-time and end-time, as well as the data and links that will be associated within it.

To manually create HoverEvents, the content provider advances through the media, identifying start- and end-times and regions of interest. The content provider may input HoverContent, that is to say, information for display during a HoverEvent. A HoverEvent that contains HoverContent and will be displayed to a viewer within The Rollover Player in a HoverBoard.

All HoverEvents will have a UUID or unique identifier, which will allow each and every event to be updated or replaced. It will also allow content providers to give HoverEvents an expiration date to either be updated or terminated. This will allow for archived material to have a longer and more vital shelf life.

HoverBoards can correspond to events within a script, book, video, photograph, as well as items and products. Regions may be merged to create custom shapes and sizes that correspond to specific on-screen items, sounds, actions and events. In this way, the grid of regions is dynamic and may be user-defined by the sponsorship in terms of size, shape and delineation and display real-time advertising. The regions can be encoded for any length of time during the content playback. Content providers can also generally tag scripts and media by entering key words, items, products, brands, events, notable timecode, themes and/or other possible moments of interest.

In addition, content providers may allow automated event creation. Rollover Encoder can suggest possible HoverEvents, either as the result of manual entry through the use of script or graphic recognition software. Script or graphic recognition software, whether internally developed or developed by a third party, may be deployed to analyze scripts and media to identify additional HoverEvents and/or generally tag scripts and media (by entering key words, items, products, brands, events, notable timecode, themes and/or other possible moments of interest). Rollover Encoder may also suggest HoverContent for empty HoverEvents or suggest fully matched HoverEvent/HoverContent pairs as Open HoverBoards.

The content provider accepts or rejects Rollover Encoder's suggestions (HoverBoards, HoverEvents, HoverContent, tags) and inputs additional HoverContent as necessary. HoverEvents that contain no HoverContent can be discarded or published as Open HoverBoards.

A content provider publishes Open HoverBoards in order allow individuals or companies (for the purpose of this document, referred to as Direct Advertisers) to display information or advertisements on Open HoverBoards. The content provider may offer HoverBoards free of restrictions or impose rules for acceptable content. For example, if a frozen-pizza company has already purchased advertising space on a HoverBoard, the content provider may wish to publish a restriction that no other advertisements or information regarding pizza may be displayed.

The content provider may allow Direct Advertisers to define additional HoverEvents, or only allow HoverContent to be added to existing HoverEvents.

When the HoverBoards, Open HoverBoards and restrictions have been defined, the content provider publishes a Rollover Encoded File to the Rollover Player Server. The Rollover Encoded File corresponds to the specific media; it is tied to its stream_id. The Rollover Encoded File may be a simple text file that ties all programmatic events (HoverBoards) to industry standard timecode and International Standard Audiovisual Numbers.

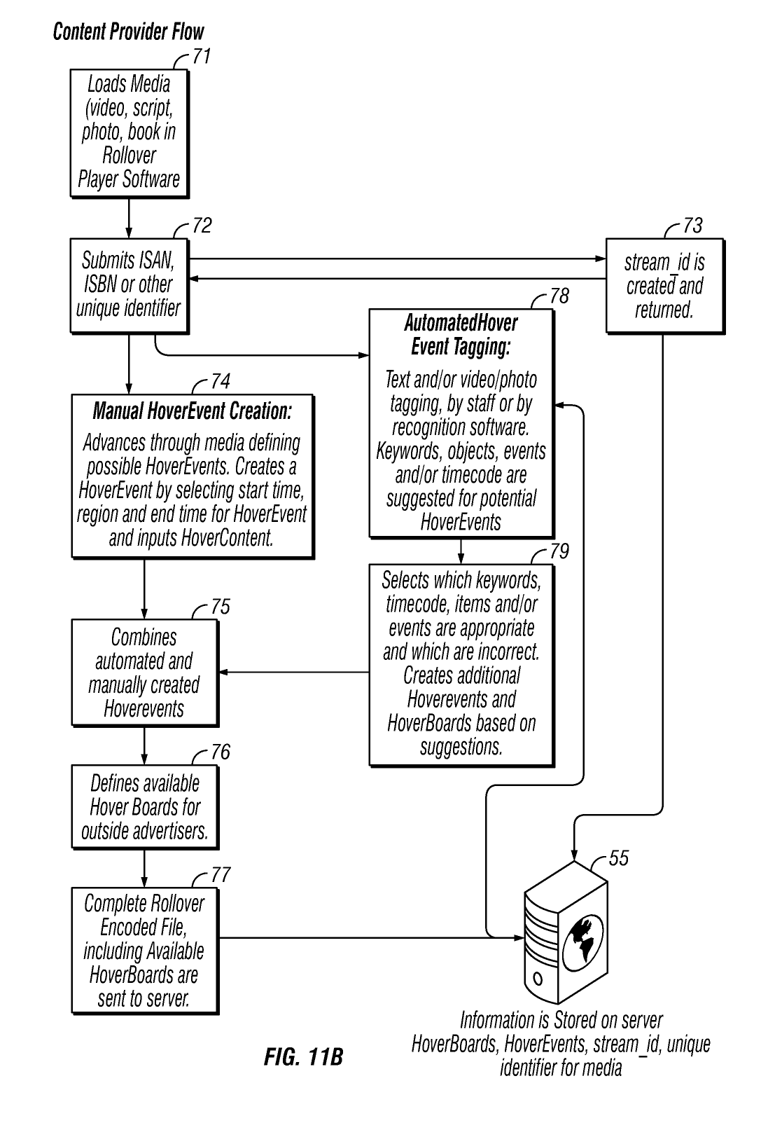

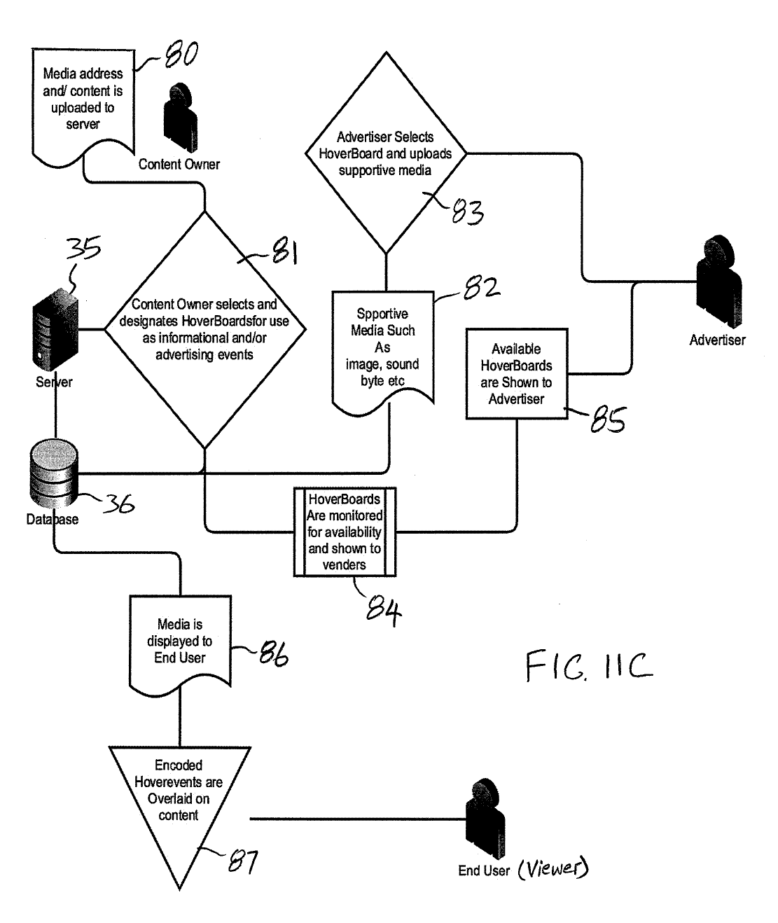

FIG. 11A illustrates schematically the interactions among the end user viewer, the content provider and the advertiser, involving stream_id, in accordance with an embodiment of the present invention. The content provider uploads document to server and server (e.g., Rollover Player Server 35) creates stream_id) (88), via a user interface 94. The stream_id, client_id, and session_id are stored in database 36 (95).

The content provider selects available HoverBoards to market to target advertisers (89). Advertise is shown the list of available HoverBoards (90). Advertiser selects HoverBoards and uploads associated content (e.g., advertisements and any supportive information) via a user interface 92 to the server 35 (91), such that HoverBoards selected by the advertiser are stored with stream_id at the server 35/database 36.

When the end user viewer uses the Rollover Player 40 to select a media for display/playback via a user interface 97 from the media server 62 (not shown; see FIG. 10B) or server 35, encoded content with stream_id is presented to viewer with encoded HoverBoards (98).

FIG. 11B schematically summarizes the process discussed above, in accordance with one embodiment of the present invention. A content provider, or encoder user, loads media (video, script, photo, book) in Rollover Encoder (71). The user submits ISAN, ISBN or other unique identifier for the loaded media (72). A stream_id is created and returned by the Rollover Encoder, with such information also stored by the server 55 (which may be the Rollover Player Server 35), which is associated with the loaded content (73). In the event of manual HoverEvent Creation, user advances through media defining possible HoverEvents. User creates a HoverEvent by selecting start time, region and end time for HoverEvent and inputs HoverContent (74). If there are automatically created Hoverevents, the Rollover Encoder combines automated and manually created HoverEvents (75). The Rollover Encoder defines available HoverBoards for outside advertisers, complete Rollover Encoded File, including available HoverBoards are sent to server 55 (77).

In the event the user chooses to employ automated HoverEvent creation, the Rollover Encoder handles automatic HoverEvent tagging, wherein text and/or video/photo are tagged, by a staff person or by a software-based recognition application. The Rollover Encoder suggests Keywords, objects, events and/or timecodes for potential HoverEvents (78). The user selects which keywords, timecodes, items and/or events are appropriate and which are incorrect. The user may also create additional HoverEvents and HoverBoards based on the suggestions by the Rollover Encoder (79). The HoverEvents created via this route are forwarded to be combined with any manually created HoverEvents (75) for further processing.

FIG. 11C schematically illustrates advertiser and content provider interactions concerning HoverBoard and Rollover Player Server, in accordance with another embodiment of the present invention. An advertiser interacts with the Rollover Player Server 35, with the user monitoring Hoverboards for available HoverBoards to be shown to target vendors/advertisers (84). Available HoverBoards are shown to the advertiser. Advertiser selects HoverBoard and upload advertising and other supportive media information (83), which may include image, sound bytes, etc. (82). The uploaded information is stored at the database 36 associated with the server 35.

When the content owner/provider uploaded media address and/or content to the server 35, the content owner/provider selects and designates HoverBoards (stored by server 35 and database 36) for use as informational and/or advertising events (81). Media is served and displayed to the Rollover Player used by the viewer end user (86), and encoded HoverEvents are overlaid on content (87), e.g., by the Rollover Player Server 35).

The application of a billboard-style overlay to the media playback or display area is one that viewers will be excited about and advertisers will be comfortable with. Advertisers are already familiar with the use of physical, roadside billboards in their revenue stream. Different factors weigh into the cost and efficacy of a physical billboard, such as length of time in use, size and location. Advertisers are also familiar with the use of in-stream advertising and the factors that weigh into the cost and efficacy of an in-stream advertisement, such as the length of time (days, weeks, months) an advertisement airs, the popularity of the program, and the demographic viewership of the program.

The convergence of these existing technologies and the inventive Rollover Player System provides advertisers with direct access to intended audiences in a way never before possible. While a physical billboard allows general viewership with some correlation between the location of the physical placement and its viewership, the correlation is broad and its effect is minimal. An in-stream ad is more specific, as advertisers hope to broadcast to the demographic viewership of a program.

The inventive Rollover Player System creates advertisement placements that are yet more specific to both program content and the program's viewership. Advertisements can correspond with program content, as in the previous examples (an on-screen dress or pizza) described. In addition to these content-related advertisements, the linking of products to demographic information can be more specific and more effective than ever before. The viewer's actual location and other demographic information may be available to the advertiser and that may provide a huge advantage over traditional revenue streams.

Direct Advertisers (advertisers, individuals or companies) may seek placement opportunities through Rollover Encoder or through a separate utility called HoverBoards. Direct Advertisers can find Open HoverBoards or manually search tags (key words, items, products, brands, events, notable timecode, themes and/or other possible moments of interest) to define additional HoverEvents, input HoverContent and create HoverBoards.

Furthermore, the exclusive viewer information obtained within the Rollover Player System may be invaluable in determining the efficacy of advertisements. Information regarding viewers' browsing histories may provide previously unavailable access to viewership. This technology may allow quantitatively tracking of viewer likes and dislikes, clickability of advertisements, length of time spent on advertisements as well as other benchmarks to create summaries of overall engagement with advertisements and information and the efficacy of that display. This information is accessed within the Rollover Player System's backend software for content coding.

The access to this information is meant to create a feedback loop in which advertisers create advertising content, viewers engage with the advertising content in a satisfying way, viewer data is stored, viewer engagement is reported on to advertisers, and advertisers can restructure their advertising and techniques to more effectively engage audiences in a way that audiences respond to, all within the Rollover Player System.

The Rollover Player System links content creators, providers and advertisers with consumers in both national and local markets, maximizing the unrealized potential of viewer interaction and participation in advertising. Through the inventive easy-to-use, backend coding and embedding software, the Rollover Player System provides rollover ads with a billboard-style billing potential as well as a dynamic database capable of queuing and saving information, providing external information and consumer purchasing opportunities. The Rollover Player system can integrate more brands per episode of content than traditional banner advertising, sponsorship, or in-stream viewing, provide more viewer-to-brand connections than traditional advertising while simultaneously providing a non-intrusive, pleasant and sophisticated experience for viewers.

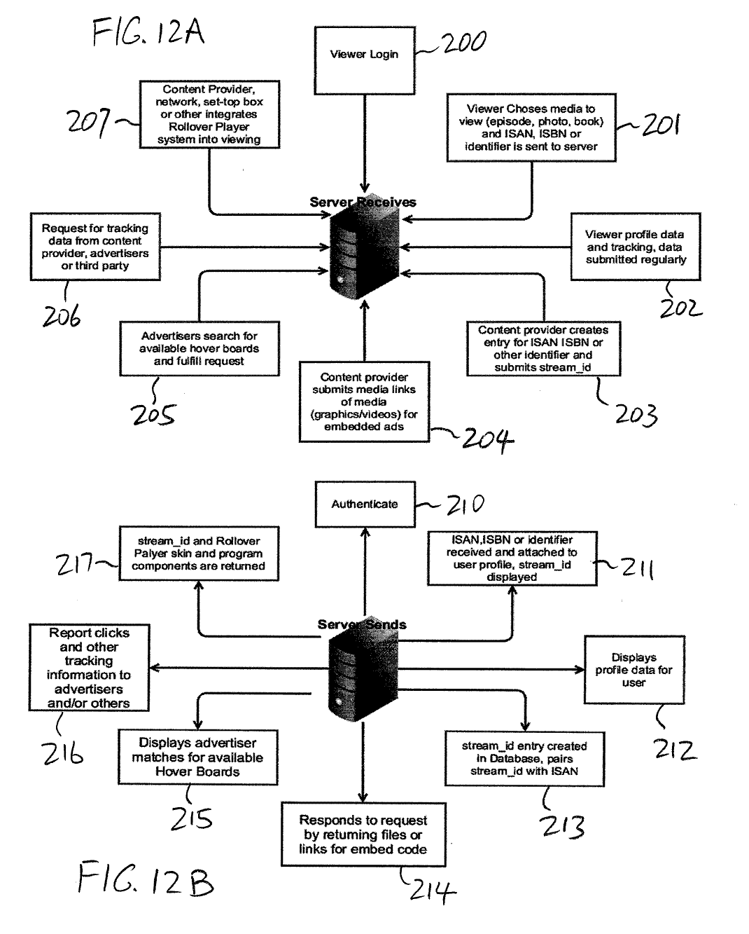

Given the foregoing discussions of the various components of the Rollover Player System, FIGS. 12A and 12B summarizes and provides an overview of server communications in The Rollover Player System in accordance with one embodiment of the present invention. FIG. 12A illustrates the external interactions of the Rollover Player Server 35 in the inputting/receiving mode, and FIG. 12B illustrates the external interactions of the Rollover Player Server 35 in the output/sending mode.

FIG. 12A shows the Server 35 inputting/receiving at least the following: (a) viewer login information (200); (b) viewer's selection of media to view (episode, photo, book) and ISAN, ISBN or other identifier sent by viewer (e.g., via Rollover Player) (201); (c) viewer profile data and tracking data submitted regularly by viewer (e.g., via Rollover Player) (d) entry for ISAN and ISBN or other identifier created by content provider and stream_id submitted by content provider (203); (e) media links or media (graphics/video/sound) for embedded advertisements submitted by content provider (204); (f) searches for available HoverBoards by advertisers and fulfillment requests from advertiser (205); (g) request for tracking data from content provide, advertiser and/or third party (206); and (h) requests from content provider, network, set-top box or others to integrate Rollover Player into their system to access media for viewing (207).

FIG. 12B shows the Server 35 outputting/sending at least the following: (a) viewer (or other user) authentication (210); (b) stream_id representing ISAN, ISBN or other identifier received and attached to user profile, and for displaying such (211); (c) user profile data to be displayed (212); (d) stream_id entry created in database, and stream_id that was paired with ISAN (213); (e) requested files or links to be embedded (214); (f) matches for available HoverBoards to advertiser for display (215); (g) report of clicks and other tracking information to advertisers and/or others (216); and (h) stream_id and Rollover Player skin and program components (217).

In one aspect of the present invention, the Rollover Player Server 35 may be the linking component between the various Rollover Player components and sub-systems, thus providing a centralized and/or unified Rollover Player System. The Rollover Player Server The database 36 (not shown in FIG. 12) in association may be hosted and/or maintained by the content providers or a third party.

Instead of displaying media streamed via a network, the media encoded with additional information in accordance with the present invention may be recorded on a digital medium (e.g., DVD, solid state drive, flash drive). The files for the additional information and the files for the media program are recorded on the same digital medium. During playback of the media program using the Rollover Player, the additional information would be available to be accessed from the same digital medium. Alternatively, instead of recording the components of the additional information are not recorded with the media program and only links are encoded in the media program. During playback using the Rollover Player, e.g., on a desktop PC connected to a data network (e.g., the Internet), the viewer can access the linked information over the network.

Rollover Player System API

The API methods are grouped into 3 main categories based on their respective users:

Rollover Player API—to be used by the end-user viewer during media playback

Rollover Encoder API—to be used by content providers, advertisers and content owners including but not limited to video, image or digital book owners, television networks, content distributors and/or online media resellers such as Netflix, Pandora, Hulu, etc.

HoverBoards API—to be used by advertisers, publishing advertising businesses or advertisement reseller networks such as Google Ads, Doubleclick, etc.

Each group provides a comprehensive array of methods for interacting with the Rollover Player Server that does not limit the end user (the viewer), content provider or advertiser to using a specific software or interface for media playback, and allows them to integrate the Rollover System into their encoding setups. The Rollover Player System will provide sample API and library usage example to ensure maximum exposure of the technology to all media distribution channels.

While the API will cover niche markets, it also will provide a gateway to closed-sourced companies, where the content provider prefers to implement and integrate the Rollover Overlay technology in-house without revealing their source code to the Rollover Player System developers.

Rollover Players may be configured with pre-built software based applications for the popular viewing platforms such as desktop PCs (Mac, Linux and Windows operating systems), Iphone and Ipad devices (iOS operating system), Android Devices as well as any other operating system platforms. The Rollover Player Programming Libraries, which may be located within the Rollover Player Server, will consist of a collection of computer code modules that would implement the Rollover Player API in popular programming languages such as but not limited to PHP, HTML5, Flash (Actionscript), Java, DHTML, C++, etc. The Rollover Player Programming Libraries will be used internally by the Rollover Player developers, but also may be made available to third-party developers in order to facilitate the implementation of Rollover system on various media playback mediums.

While the libraries will each speak their individual language, they will make use of the underlying API requests. Such requests will be sent on the network layer using a SOAP, JSON, custom XML or REST formatting. Below is a sample API request and its corresponding library call, the call extracts all events for a specific media for which the stream_id has been previously determined. The Rollover Player Server's response to this request will be a document formatted using the XML encoding described above.

Sample API REST request:
http://rollover-api-server.com/get.php?
stream_id=23232&method=event_list&format=xml

Sample C++/PHP/Java Library request:
rollover_get_events(23232, ‘xml’);

The media overlay technology used in The Rollover Player is part of The Rollover Player API and Software Libraries. While its implementation will differ from one platform to another, its concept remains the same across platforms, consistent with the configuration schematically illustrated in FIG. 4A.

A sample implementation of the overlay technology follows. Because HTML5-based video players dominate the desktop web delivery market for video streaming we will provide an overview of the Rollover Player Overlay implementation for this platform. This implementation will be packaged as a software library and will be made available to all developers interested in integrating their Flash video player with the Rollover Player System.

Typically, in a HTML5 player the media playback is implemented using the objects and methods provided by browsers or host software. Media playback can be accomplished by using the HTML5 video component that also provides a way to customize the play, pause, skip and progress tracking video player functions. However, more advanced developers will use the HTML5 video component in conjunction with the Javascript programming to gain more control over the playback process. In any case, the HTML5 video object provides a way to overlay objects over a video rendering window by the means of its intrinsic “layered” topology. Thus the Rollover Player library will provide a simple call that will create an overlay object on top of the video player object that is passed as a parameter to this function: RolloverPlayerAttach (videoPlayer). Once the playback of a specific title starts, the player will register the video stream_id so that a proper event list can be obtain from the Rollover Player Server: RolloverPlayerRegisterVideo(‘235456’). Once attached to a video player the Rollover component registers an event listener for the VideoProgressEvent on the videoPlayer object. Thus the Rollover object is aware of the video progress and displays the content on the Rollover Player based on the event list timing properties.

In case of advanced timing (such as graphic recognition), the video processing is done in advance and all dynamic events are converted to absolute events for storage on the Rollover Player Server. In other words, if the event list specifies the timing of an event to be when “pizza” object is detected, all occurrence of this object will be pre-computed and delivered by the Rollover Player Server.

The Rollover Player API establishes an object called the HoverBoardEvent. HoverBoardEvent is a specific content being programmatically displayed in one of the grid cells. Each event has the following “properties” that can be encoded in a suitable way based on the video delivery medium (web, television, mobile television, etc). Event properties may include:

Client ID—unique identifier for device used to access Rollover Player

User ID—unique identifier used to track unique users

Session ID—an identifier used to track session information, such as duration of played content.

Event ID—the purpose of this string is to uniquely identify each event in the Rollover Player Database

Stream ID—this is a unique identifier for the media stream that allows access to more information via the Rollover Player registered titles database and the Rollover Player API

Region—this defines the region where the event's content will appear, it specifies the cell and grid type or may specify a custom region based on exact pixel values, or relative percentage values based on the media stream width and height

Action—this is the action that is taken once user “interacts” with the event's region, the interaction may consist of but is not limited by “click”, “mouse-over”, “tap”, “swipe” actions as defined on the respective media rendering medium. The action may consist of but is not limited to “visiting a webpage” (in same or new window), “opening another media stream”, “splitting the screen and displaying additional content”.

Timing—defines when the event will appear and how long it will last. It may be defined as absolute value (seconds) since the start of the media stream, or a relative value based on a detectable feature such as a face/object recognition, keyword detection in speech or in the subtitle stream. Similarly, the end of the event can also be specified as an absolute value (duration in seconds), or based on a detectable feature.

Content—specifies the content that would appear upon user interaction, this is generally encoded in HTML format. Content can contain other objects such as but not limited to images, videos, audio streams, scripts, digital books etc. included by reference (external url) or being embedded and encoded for example with one of MIME binary-to-text encodings (base64, quoted printable, BinHex, Percent Encoding, yEnc, etc.)

The network communication is implemented inside the RolloverPlayer object using the XMLHttpRequest object, that is part of the Javascript API. This allows to send REST requests to the Rollover Player Server such as:

http://rollover-api-server.com/get.php?stream_id=23232&method=event_list&format=xml and receive an XML file as a response.

Furthermore, the XML file is parsed using Javascript, which allows access to the event list to be displayed on the Rollover Player Overlay as well as all properties of these events that determine the content, timing and actions associated with each event.

An example of XML Encoding is as follows:

<xml>
<event id=”322323”>

<stream id=”45874”>

<url>http://youtube.com/2342342323</url>

</stream>
<region cell=”A7” grid=”simple” />
<timing start=”3:06” length=”0:30”/>
<action type=”click” url=”http://advertiser-url.com/destination “/>
<content><![CDATA[ <div><a href=”
http://advertiser-url.com/destination”>Get

This Product at half price</a></div ]]></content>
</event>
</xml>

Encoding is not limited to XML format. It is chosen as a demonstration for the purpose of this document due to its explicit format that allows a human (not just a computer) to easily read and understand it. Other equivalent formats such as plain text or binary can and may be selected and used based on the delivery medium.

The process and system of the present invention has been described above in terms of functional modules in block diagram format. It is understood that unless otherwise stated to the contrary herein, one or more functions may be integrated in a single physical device and/or software module in a software product, or one or more functions may be implemented in separate physical devices and/or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules, hardware and software components in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. For example, the various electronic applications can be easily modified to incorporate different or additional processes to provide additional flexibility in connection with linking and rendering additional information, and delivering and displaying media along such information. Accordingly, it is to be understood that the invention is not to be limited by the specific illustrated embodiments, but only by the scope of the appended claims.

I claim:

1. A method of displaying media with additional information using an electronic device having a display screen and a processing unit, the method comprising:
defining encoded regions in a display area of the display screen, wherein the encoded regions are associated with the additional information that will be displayed when selected by a viewer;
providing a utility that facilitate encoding the additional information in synchronization with the media and in association with the encoded regions;
providing a player application which displays an image of the media in a designated display area of the display screen, and renders the additional information associated with a selected encoded region when a viewer places a pointer selectively over the selected encoded region of the display area,
wherein the processing unit is configured to run the player application and render images on the display screen in accordance with requirements of the player application.

2. The method of claim 1, wherein the pointer is a cursor associated with a pointing device.

3. The method of claim 1, wherein the additional information is synchronized to the media based on timecode.

4. The method of claim 1, wherein the additional information is a link to content stored at a remote server.

5. The method of claim 1, wherein the encoded regions are arranged in a grid.

6. The method of claim 6, wherein the grid comprises rectangular areas defining the encoded regions.

7. The method of claim 1, wherein the additional information is contextual to the content of the image of the media currently displayed when the viewer places the pointer over the selected encoded region.

8. The method of claim 1, wherein the player application is configured to display media that is streamed, with the additional information synchronized to the streamed media.

9. An interactive electronic device for displaying media with additional information, comprising:
a display screen;
a processing unit running a player application to display an image of the media in a designated display area of the display screen, wherein display area defines encoded regions that are associated with the additional information that will be displayed when selected by a viewer;
wherein the media includes additional information encoded in synchronization with the media and in association with the encoded regions
wherein the processing unit is configured to run the player application and render images of the media in the display area in accordance with requirements of the player application, and wherein the player application renders the additional information associated with a selected encoded region when a viewer places a pointer selectively over the selected encoded region of the display area.

10. A system for displaying media with additional information, comprising:
an interactive electronic device as in claim 9;
a remote server storing the additional information for encoding the encoded regions;
wherein the electronic device communicates with the remote server over a network.

11. A system as in claim 10, wherein the system is centralized and unified.

12. A system as in claim 10, wherein the system further comprising an encoding application to encode the encoded regions with the additional information.
